(19) United States
(12) Patent Application Publication
(10) Pub. No.: US 2020/0032766 A1
(43) Pub. Date: Jan. 30, 2020

(54) System and Method for Converting Mechanical Energy Produced by Ocean Currents into Electric Power

(71) Applicant: Larry Alva Johnson, Wellington, FL (US)

(72) Inventor: Larry Alva Johnson, Wellington, FL (US)

(21) Appl. No.: 16/020,570

(22) Filed: Jul. 24, 2018

(51) Int. Cl. F03B 17/06; F03B 13/10; B63B 35/44

(52) U.S. Cl. CPC F03B 17/06; B63B 2035/4466; B63B 35/44; F03B 13/10

(57) ABSTRACT

A system for converting the mechanical energy produced by the flow of ocean currents into electric power including a first and second floating structure, a first pulley device supported on the first and second structure, and a second pulley device supported on the first and second structure. A first continuous cable is configured to be suspended from the first pulley device supported on said first and second structure. A second continuous cable is configured to be suspended from the second pulley device supported on the first and second structure. A sail implement is configured to collect mechanical energy from the ocean currents, and wherein the sail implement is operable for transmitting the mechanical energy to the first continuous cable and the second continuous cable. A generator device is operable for transforming the mechanical energy from the continuous cables into electrical power.

### CROSS-REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to generating energy. More particularly, certain embodiments of the invention relates to generating energy from ocean water currents.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that there has long been research for natural and sustainable sources of energy production that limit environmental pollution or damage. Typical primary sources currently used for this purpose are wind energy and solar energy. Ocean energy, which includes harnessing the kinetic energy of tides, waves or currents, is commonly another source of sustainable energy that has been explored. Many ocean currents, like the Gulf Stream are usually located close to land and close to large populated areas. Ocean currents typically have stable and predictable current directions and velocities. Ocean currents are usually large natural and sustainable power sources.

The development of power generation equipment to collect and transform the kinetic energy of ocean currents has commonly been limited due to the difficulty of the ocean environment. Known concepts typically use some form of rotating blades, fans or propellers to transform the slow-moving current into mechanical energy in a shaft. Such rotating blades must turn rapidly to provide sufficient power for a given size. While propellers can transfer large amounts of power, they usually require the propeller to turn very rapidly or be extremely large to transmit useful amounts of power. Ocean currents are generally less than 10 miles per hour meaning that a large volume of water must be collected to transform its kinetic energy into a useful amount of power for industrial and utility purposes. Furthermore, using propeller blades at a relatively high velocity risk damage of the blades or hitting marine animals.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B, and 1C illustrate various views of an exemplary ocean energy mechanical power generator and barges, where FIG. 1A illustrates a top view of an ocean energy mechanical power generator, FIG. 1B illustrates a side view of an ocean energy mechanical power generator, and FIG. 1C illustrates a top view of two barges, in accordance with an embodiment of the invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user,” or any similar term, as used herein, are generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may provide an improved ocean energy mechanical power generator using sail or parachute like mechanisms to collect ocean energy. The sail or parachute like mechanisms, hereafter described as sails, may be made of various natural or man-made materials suitable for ocean use, in various configurations intended to effectively control a portion of water within the ocean current. The sail like mechanisms may comprise multiple shaped sails including but not limited to square shaped sails, rectangular shaped sails, circular shaped sails, sails having three or more corners, etc. The sail like mechanisms may incorporate weights to hold them below the ocean surface, buoys to hold the top of the sails up, various methods to maintain the shape of the sail, suitable reinforcement of the sail material at heavily stressed locations and connections to supporting cables described elsewhere.

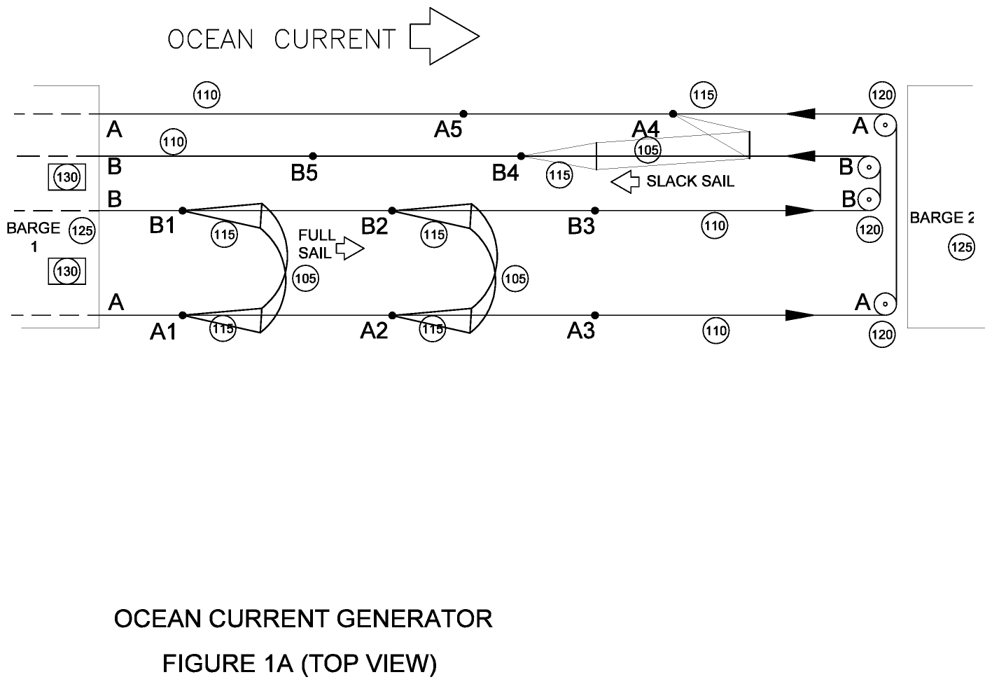

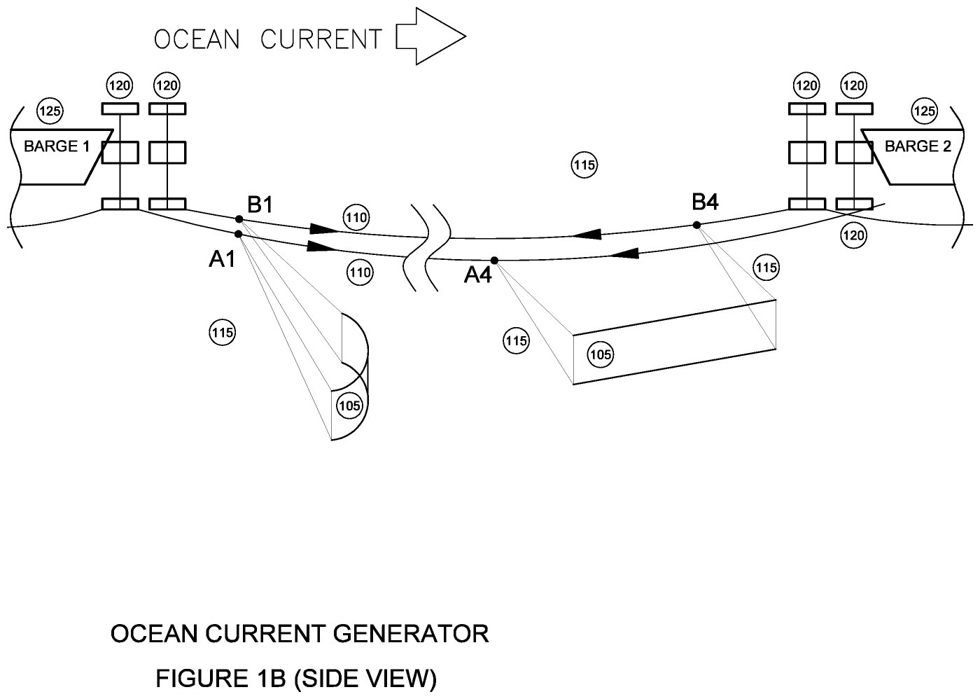

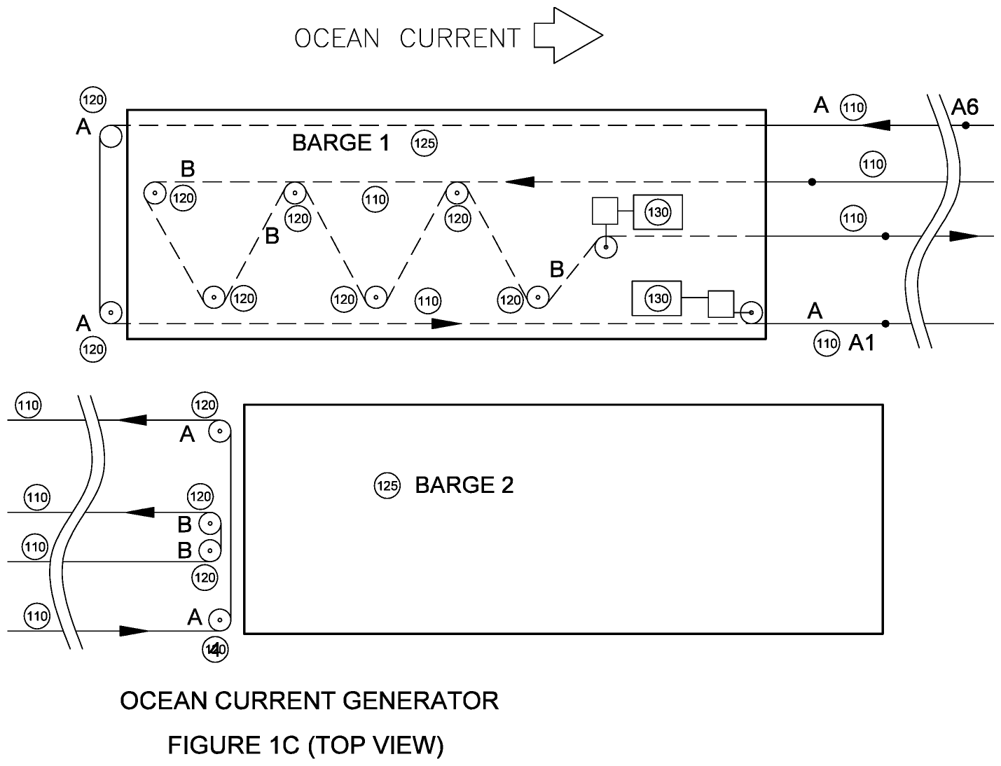

An embodiment of this invention may relate to a horizontal system of moving cables, ropes, or lines, hereafter called cables for purposes of description. The cables made be made from natural or man-made materials of various configurations, including but not limited to wire rope, steel cabling, chain, steel bar links or hawsers. The cables may be suspended from pulleys or appropriate mechanical support structures, which may be located on one or more floating or stationary structures, such as barges, ships, floating platforms or stationary permanent platforms. Alternatively, the cables may be supported from structures or vessels located under the sea. The stationary or floating structures, hereafter named barges for purposes of description, may be anchored or otherwise restrained so that they are stationary located on the ocean surface within an ocean current. The barges may be located some distance (optimally within 5 and less than 20 miles apart. The total length of the continuous cables is only limited by the number of barges used, arranged so that the first barge is upstream of subsequent barges. The number of barges is optimally 2 to 10 and less than 50. Underwater sails may be connected to continuous cables by multiple smaller vertical cables so that the mechanical energy collected by the sails is transmitted to the continuous cables. The continuous cables may include at least two or more continuous cables and the underwater sails may include at least two or more underwater sails. In one embodiment, four or more corners of the underwater sail may be connected to the vertical cables where two or more corners of a first side of the underwater sail may be connected to a first continuous cable and the other two or more corners of a second side of the underwater sail may be connected to a second continuous cable. The relative position of the first and second continuous cables and vertical cables supporting each side of each sail may be changed, so that the sails may be fully loaded to catch an ocean current while travelling in a direction of current flow and collapsed or slack when travelling in an opposite direction. The change in the relative position of the two continuous cables may be accomplished by having one/first continuous cable travel further at the downstream end of the continuous cables, so that the vertical cables supporting each sail are separated from those on the other/second continuous cable while they travel in the direction opposite to the current. The other/second continuous cable may travel further at the upstream end of the continuous cables so that the vertical cables supporting each sail are the same distance from the starting point while the cables move with the current. Various cable configurations may be used to accomplish these changes in relative position of the continuous cables, depending on space constraints and the need to prevent either continuous cable from crossing the other. One configuration is shown on FIG. 1C. An alternative configuration may entail having each continuous cable move vertically up and down to provide for the longer travel distance at the respective end of the continuous cables. Other configurations that accomplish the same function are included in the invention. The sails may have various configurations designed to be weighted and maintain their shape in the ocean, maximize energy transfer from an ocean current to the sail and allow for retrieval to a barge and deployment from a barge. Mechanical energy from sails and moving cables may be transformed into electricity through a system of gears, mechanical devices and generators which may be connected to one or more of the continuous cables. The mechanical energy may also be used to produce a variety of industrial products, including but not limited to hydrogen, oxygen, chlorine, salt, etc. Floating barges may be held in place by anchors, cables between barges or suitable support from service vessels. A mechanical system or system of weights and pulleys may maintain tension on cables while cables may be moving and barges may be moving relative to each other.

In some embodiments, a method to extract power from ocean currents is provided in accordance with the teachings of the present invention, by deploying multiple large underwater sails, connected by continuous cables and pulleys, and supported from ships, barges or platforms so that continuous cables may be parallel to the ocean current flow. The sails may be of different configurations and materials, and may be deployed at the same or different underwater elevations to maximize the power collected by the sails. Alternatively, the sails and cables may be supported from underwater structures or vessels.

In other embodiments, a method to extract power from ocean currents is provided in accordance with the teachings of the present invention, by deploying multiple large underwater sails, connected by continuous cables and pulleys, and supported from ships, barges or platforms so that the continuous cables are parallel to the ocean current flow. The sails may be of different configurations and materials, and may be deployed at the same or different underwater elevations to maximize the power collected by the sails. Alternatively, the sails and cables may be supported from underwater structures or vessels. Underwater sails may collect energy from ocean currents by being fully loaded while moving with the ocean current and then being slack or unloaded while returning to the starting point. Two continuous cables may support the underwater sails and transform kinetic energy to mechanical energy. A mechanism may change the length of travel of one of the continuous cables at the downstream end of its travel, so that the underwater sail is positioned parallel to the ocean current and is unloaded during its travel back to the starting point. A mechanism may change the length of travel of the other continuous cable at the upstream end of its travel, so that both cables may come back to the same relative point at the starting point of travel and the sail may be fully loaded by the ocean current.

In additional embodiments, a method is provided in accordance with the teachings of the present invention, to control the speed and tension of the continuous cables and extract mechanical energy from the moving cable through a system of pulleys, shafts and gears, instrumentation and controls may be used to sense and control the speed and tension of the continuous cables, so that the sails may extract the maximum practical kinetic energy from the ocean current.

In further embodiments, a method is provided to generate mechanical and/or electrical power from ocean currents in accordance with the teachings of the present invention, that may use a system of pulleys, shafts, gears and alternating current (AC) or direct current (DC) electric generators, voltage transformers, electrical power conditioning equipment and undersea electrical cables to generate, condition and transmit electrical energy to the utility power customer. Instrumentation and controls may be used to control the frequency and voltage of the electricity. Alternatively, a system to convert the mechanical energy from ocean currents into useful fuels or products including but not limited to hydrogen, and oxygen through known industrial processes may be used.

FIGS. 1A, 1B, and 1C illustrate various views of an exemplary ocean energy mechanical power generator and barges, where FIG. 1A illustrates a top view of an ocean energy mechanical power generator, FIG. 1B illustrates a side view of an ocean energy mechanical power generator, and FIG. 1C illustrates a top view of two barges, in accordance with an embodiment of the invention. The encircled numbers shown on the figures refer to the numbered descriptions on FIG. 1A (ie. 105 UNDERWATER SAIL). The letters A, B refer to portions of the two continuous cables, to clarify the direction and configuration of each continuous cable as shown in this description of the embodiment. The letters A1 and B1, A2 and B2, . . . A5 and B5 may refer to the connection points between the vertical cables supporting a particular numbered sail and the two continuous cables, (A1 and B1 refers to the first sail connected to continuous cables A and B respectively).

In FIG. 1A, multiple large underwater sails 105 may catch kinetic energy from an ocean current and may transform it to mechanical energy in two continuous cables 110, one supporting either side of sails 105. These sails 105 may be arranged to be fully loaded when travelling parallel to a current flow and collapsed or slack when returning in an opposite direction to a starting point. Locations A1 and B1 as shown on FIG. 1A are defined to be the “starting point”, for purposes of description. The sails 105 may be deployed at different elevations so that one sail 105, connected to points A1 and B1, may not reduce power to downstream sails 105, connected to A2 and B2. The sails 105 may travel at less than an ocean current speed, so that they may effectively capture kinetic energy of water in the ocean current. The sails 105 may have various configurations designed to maximize energy transfer from a current to the sails 105. The sails 105 may be weighted on the bottom and buoyed on the top so that they may remain open and underwater when deployed. The sails 105 may be retrieved onto a barge 125 when not in use. The sails 105 may be of various organic or man-made materials designed to withstand the ocean environment, including but not limited to sail cloth, plastics, metals or combinations of those materials. Two large continuous cables 110 may be suspended from pulleys 120 located on barges 125 anchored a long distance (optimally within five miles and unlimited except by the number of supporting barges 125) from each other in a direction of ocean current flow. Continuous cables 110 may be separated horizontally so that they may keep sails 105 open and catching water when they may be deployed in a direction of ocean current travel. Continuous cables 110 may be kept under tension by a mechanical system so that the cables 110 may maintain their shape while barges 125 move slightly relative to each other. The continuous cables 110 may be at or below the ocean water surface near pulleys 120, and may be substantially below the ocean water surface between barges 125 so that they may not inhibit marine surface vessel travel. The continuous cables 110 may have a cable tensioning system to maintain tension on moving cables, and a system to retrieve and deploy continuous cables 110, when a system is not in use or when the barges 125 must be moved. One of various methods for this purpose similar to those used for cable cars or ski lifts may be employed. The continuous cables 110 may be arranged so that one side (cable A) may travel a longer distance on one end of its travel, and another cable 110 (cable B) may travel a longer distance at the other end of its travel. The change in distance of travel of each continuous cable 110 may be sufficient for the connections to the sails 105 (shown as A1 and B1, A2 and B2, etc.) to be equal distance from the “starting point” while the sails 105 are moving in the direction of current flow so that the sails 105 are fully loaded. When the continuous cables 110 are travelling counter to the direction of current flow, the connections to the sails 105 (shown as A4 and B4, A5 and B5) are sufficiently spread apart so that the connected sails 105 are not loaded or slack. While only five sails 105 are indicated on the Figures for purposes of description, the number of multiple sails is unlimited depending on the length of the continuous cables 110. The distance of separation may optimally be less than one sail length up to ten sail lengths, and may exceed 50 sail lengths. This may allow sails 105 to move continuously and may reduce a drag of a sail 105 while it may be moving against the current flow. A difference in force between sails 105 moving in the direction of current flow vs. those sails 105 moving against the current flow may cause the continuous cables 110 to move and create mechanical energy.

In some embodiments, continuous cables 110 may have multiple vertical cables 115 supporting each underwater sail 105. Continuous cables 110 may be supported by pulleys 120 designed to support a cable without tangling smaller vertical cables 115. Vertical cables 115 may be of different lengths and arrangements for a specific underwater sail 105, and may allow adjacent sails 105 to be arranged at different water depths so that a flow from one sail 105 does not affect water flow to adjacent sails 105. Pulleys 120 may support continuous cables 110 while not tangling or breaking smaller vertical cables. At least one pulley 120 on each of two continuous cables 110 may be connected to a system of gears, shafts and/or pulleys 120 that may control a speed of a cable and transmit power to electric generators 130. Barges, ships or platforms 125 may support various equipment, may allow relocation of equipment to new ocean locations and may support operating and maintenance staff. Navigational and safety equipment may warn other vessels from an area. Barges, ships or floating platforms 125 may be moved to a site and then anchored so that they may not be moved by an ocean current. Barges 125 also may have equipment to deploy, retrieve and store continuous cables 110, vertical cables and sails 105 when they may not be in use. Pulleys 120, shafts, gears, and generators 130 may transform mechanical energy from continuous cables 110 into electrical power. Shafts, gears and a generator 130 may be located on a barge 125 above water level, which may substantially reduce the cost of equipment, compared to equipment designed for submergence in ocean water. A generator 130 may be either alternating current (AC) or direct current (DC) power. The generator 130 may include voltage transformers, power conditioning systems, and control systems that may take a varying power and convert it into usable electrical power that may be transmitted to shore through undersea cables. Gears and generators 130 may be mounted horizontally or vertically. Furthermore, a control system may measure and control a speed of cables, energy being produced, tension of cables and electricity generated so that it may be transmitted to an on shore electric utility via one or more undersea cables.

In other embodiments, barge 1 125 and a Barge 2 125 may be arranged to support the invention on the surface of an ocean. These barges 125 may be anchored and arranged parallel to a direction of an ocean current flow, with a predetermined distance between the barges 125. Multiple underwater sails 105 may be connected to two continuous cables 110 that may run between the two cables. The underwater sails 105 may collect large amounts of water and may reduce the velocity of the water flow collected by the sail, and thus may capture kinetic energy of a current.

FIG. 1B illustrates a side view of one embodiment of the invention for descriptive purposes and not to limit the invention, showing two continuous cables 110 supported from pulleys 120 mounted on two barges 125 for purposes of description. Multiple barges 125 (up to 50) may be used to support the continuous cables 110. Underwater sails 105 may be connected to continuous cables 110 with vertical cables that maintain an underwater shape of a sail 105 and transfer power from a sail 105 to continuous cables 110. A length and arrangement of vertical cables may be adjusted to prevent water flow from a sail 105 affecting an adjacent sail 105. FIG. 1B further illustrates “full” underwater sails 105 as they may move toward Barge 2 125 and a “slack” sail 105 as it returns to Barge 1 125. Continuous cables 110 may droop under an ocean surface sufficiently that they may not disturb marine surface vessel traffic when cables may not be near the barges 125.

FIG. 1C illustrates a top view of two exemplary barges 125, showing one embodiment of the invention for descriptive purposes and not to limit the invention. This embodiment of the invention may increase the distance of travel of one continuous cable A on the downstream barge 2 125 and may change the distance of travel of the other continuous cable B on the upstream barge 2 125. This embodiment may provide for continuous cables 110 to keep ends of underwater sails 105 perpendicular to a current flow while a sail 105 travels with current. A continuous cable 110 on one side then may run further at Barge 2 125, so that a sail 105 may be held parallel to a current flow on its return to Barge 1 125. This may be accomplished with additional pulleys 120 mounted on sides or an end of a barge 125 to direct one continuous cable 110 on a longer path before it turns and rejoins a second continuous cable 110. By having one continuous cable 110 travel a longer distance on Barge 1 125 and another cable travel a longer distance on Barge 2 125, the two cables may come back to a same relative point at Barge 1 125 when sails 105 start in a direction of a current flow. Alternate arrangements including changes in continuous cable 105 distance of travel using changes in cable direction in the horizontal or vertical planes are included within the embodiments in the invention.

FIG. 1C further illustrates an arrangement of shafts, gears and mechanical equipment that may connect a pulley 120 or other mechanical device for each continuous cable 110 to one or more electric generator(s) 130 mounted on one of the barges 125. Generators 130 may transform a kinetic energy of cables into electric energy that may be conditioned and transmitted to an electric utility for sale.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing energy generation according to the present invention will be apparent to those skilled in the art. Various aspects of the invention have been described above by way of illustration, and the specific embodiments disclosed are not intended to limit the invention to the particular forms disclosed. The particular implementation of the energy generation may vary depending upon the particular context or application. By way of example, and not limitation, the energy generation described in the foregoing were principally directed to generating energy from ocean water currents implementations; however, similar techniques may instead be applied to converting kinetic energy to industrial products including but not limited to hydrogen, oxygen, chlorine, salt, acids or metals.

An alternative embodiment of the invention may include varying the distance of travel of the continuous cables at the upstream or downstream ends of the cables using pulleys that allow the continuous cable to move vertically up and down in a half loop, so that one cable travels a longer distance at the downstream end of cable travel and the other cable travels farther at its upstream end of travel. These implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A system comprising:
a first structure, wherein said first structure comprises at least one of a first stationary structure;
a second structure, wherein second first structure comprises at least one of a second stationary structure;
a first pulley device, in which said first pulley device comprises at least one or more pulleys supported on said first and second structure;
a second pulley device, in which said second pulley device comprises at least one or more pulleys supported on said first and second structure;
a first continuous cable, wherein said first continuous cable is configured to be suspended from said first pulley device supported on said first and second structure;
a second continuous cable, wherein said second continuous cable is configured to be suspended from said second pulley device supported on said first and second structure;
a sail implement, wherein said sail implement is configured to collect mechanical energy, and wherein said sail implement is operable for transmitting said mechanical energy to said first continuous cable and said second continuous cable;
a generator device, wherein said generator device is configured to be into engagement with said first and second continuous cables, wherein said generator device is operable for transforming said mechanical energy from said continuous cables into electrical power.

2. The system of claim 1, further comprising a vertical cable implement, in which said vertical cable implement is configured to engage said sail implement to said first continuous cable and said second continuous cable.

3. The system of claim 2, in which said sail implement comprises at least one of a rectangular and a square shaped sail having four corners, two corners in each side of said sail implement.

4. The system of claim 3, in which said vertical cable implement comprises at least four or more vertical cables, wherein two vertical cables engages said two corners of a first side of said rectangular shaped sail to said first continuous cable and two vertical cables engages said two corners of a second side of said rectangular shaped sail to said second continuous cable.

5. The system of claim 4, in which said sail implement comprises at least two or more sails, wherein each sail is configured to collect mechanical energy, and wherein each of said sail is operable for transmitting said mechanical energy to said first continuous cable and said second continuous cable.

6. The system of claim 5, in which said sail implement is configured to collect mechanical energy of flowing water in a current produced by a portion of an ocean.

7. The system of claim 6, in which a bottom portion of said sail implement is configured to engage a weight device, wherein said weight device is operable for pulling said bottom portion of said sail implement below a top surface of the ocean.

8. The system of claim 7, in which a top portion of said sail implement is configured to engage a buoy device, wherein said buoy device is configured to pull the top portion of said sail implement up.

9. The system of claim 8, wherein said sail implement is further configured to be operable for remaining open and underwater by said weight device and said buoy device when deployed.

10. The system of claim 9, in which said sail implement is configured to be fully loaded when travelling parallel to a current flow and collapsed or slack when returning in an opposite direction to a starting point.

11. The system of claim 5, in which said first structure further comprises a first barge and said second structure further comprises a second barge.

12. The system of claim 11, in which said first barge and said second barge are located at least within 5 miles and less than 20 miles apart.

13. The system of claim 12, further comprising at least one of, an instrumentation and a control being configured to be operable for sensing and controlling a speed or tension of said first and second continuous cables.

14. The system of claim 13, in which said generator device being operable for transforming said mechanical energy from said continuous cables into electrical power comprises at least two or more generators mounted on said first barge.

15. A system comprising:
means for collecting mechanical energy from ocean currents;
means for receiving said mechanical energy;
means for engaging said collecting means to said receiving means;
means for transforming said mechanical energy from said receiving means into electrical power, wherein said transforming means is into engagement with said receiving means;
means for suspending said receiving means; and
means for supporting said suspending means.

16. A system comprising:
a first structure, wherein said first structure comprises at least one of a first floating structure;
a second structure, wherein second first structure comprises at least one of a second floating structure;
a first pulley device, in which said first pulley device comprises at least one or more pulleys supported on said first and second structure;
a second pulley device, in which said second pulley device comprises at least one or more pulleys supported on said first and second structure;
a first continuous cable, wherein said first continuous cable is configured to be suspended from said first pulley device supported on said first and second structure;
a second continuous cable, wherein said second continuous cable is configured to be suspended from said second pulley device supported on said first and second structure;
a sail implement, wherein said sail implement is configured to collect mechanical energy, and wherein said sail implement is operable for transmitting said mechanical energy to said first continuous cable and said second continuous cable;
a vertical cable implement, in which said vertical cable implement is configured to engage said sail implement to said first continuous cable and said second continuous cable;
a generator device, wherein said generator device is configured to be into engagement with said first and second continuous cables, wherein said generator device is operable for transforming said mechanical energy from said continuous cables into electrical power.

17. The system of claim 16, in which said sail implement comprises at least one of a rectangular and a square shaped sail having four corners including two corners in each side of said sail implement, and in which said vertical cable implement comprises at least four or more vertical cables, wherein two vertical cables engages said two corners of a first side of said rectangular shaped sail to said first continuous cable and two vertical cables engages said two corners of a second side of said rectangular shaped sail to said second continuous cable.

18. The system of claim 17, in which said sail implement comprises at least two or more sails, wherein each sail is configured to collect mechanical energy, and wherein each of said sail is operable for transmitting said mechanical energy to said first continuous cable and said second continuous cable.

19. The system of claim 16, in which a bottom portion of said sail implement is configured to engage a weight device, wherein said weight device is operable for pulling said bottom portion of said sail implement below a top surface of the ocean.

20. The system of claim 19, in which a top portion of said sail implement is configured to engage a buoy device, wherein said buoy device is configured to pull the top portion of said sail implement up toward the top surface of the ocean, and wherein said sail implement is further configured to be operable for remaining open and underwater by said weight device and said buoy device when deployed.
